(19) United States
(12) Patent Application Publication
(10) Pub. No.: US 2006/0277106 A1
(43) Pub. Date: Dec. 7, 2006

(54) Method of creating and distributing sponsor-imprinted content used to catalyze consumer engagement with the sponsor

(76) Inventor: Linda Wright, Denver, CO (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/446,082

(22) Filed: Jun. 2, 2006

Related U.S. Application Data
(60) Provisional application No. 60/687,233, filed on Jun. 3, 2005.

(51) Int. Cl. G06Q 30/00

(52) U.S. Cl. 705/14

(57) ABSTRACT

A method of creating and distributing sponsor-imprinted content used to catalyze consumer engagement with the sponsor. A content provider creates a content complex by imprinting content, (e.g., a narrative work), with a sponsor communication. The content and the sponsor communication may be serialized. The content complex is licensed to a provider of a vehicle, (e.g., a magazine, newspaper, radio, television, or a Web site accessed via the Internet), which presents the content complex to an audience. Accountable members of the audience become consumers of the content complex. Additionally, independent consumers request the content complex prior to becoming accountable members of the audience. The content provider collects a fee from the sponsor based on the number of requests received for the content complex. The content provider pays a fee to the provider of the vehicle based on a measured consumer engagement yield.

### CROSS REFERENCE TO RELATED APPLICATION

This application claims the benefit of U.S. Provisional Application No. 60/687,233 filed Jun. 3, 2005, which is incorporated by reference as if fully set forth herein.

### FIELD OF INVENTION

The present invention is generally related to a method of advertising, (i.e., directing sponsor announcements toward potential consumers of products or services). More particularly, the present invention is related to a method of creating and distributing sponsor-imprinted content used to catalyze consumer engagement with the sponsor.

### BACKGROUND

Prior art methods for creating awareness among consumers generally include advertising and sponsorship. These methods utilize a vehicle to communicate with a potential consumer. As the consumer engages with the vehicle, an opportunity exists to convey to the consumer the advertiser's announcement or the sponsor's logo. Thus, the advertiser or sponsor indirectly communicates with potential consumers through the vehicle.

Advertisers and sponsors realize the inefficiency inherent in these methods. For example, even though the consumer uses or acquires the vehicle, the consumer may not favorably receive and engage with the advertiser's announcement or the sponsor's logo. Furthermore, there is no way of determining the number of consumers that do receive or pay attention to the advertiser's announcement or the sponsor's logo. In the case of an advertiser, the vehicle may be, for example, television, radio, print media, billboards, or the Internet. In the case of a sponsor, the vehicle may be, for example, an activity, event, organization, or third-party product.

Advertising is the method most commonly used to promote consumer awareness for an idea, product, or service. Persuasion is the preferred method of advertising. Businesses and organizations pay fees to have persuasive messages disseminated by one or more types of vehicles, including television, radio, newspapers, magazines, direct mail, telemarketing, billboards, the Internet, and the like. The advertisement exists for no other reason than to promote a product, service, or idea of the advertiser. Awareness occurs if the consumer receives the message and passively considers it. Wide-awareness can be achieved when many advertisements are disseminated by many vehicles.

Advertising is discrete communication. Its promotional message is distinct and separate from the media content with which it is conveyed to the consumer. For example, a television commercial interrupts a program; newspaper and magazine advertisements are distinct and separate from the news reports or articles; and radio advertisements interrupt the broadcast of music, news, or talk. This frustrates the consumer and results in neglect, purposeful skipping, or the application of digital devices which cancel the advertisement.

There are many forms of advertising, including roadside billboards, bus stop posters, various types of print media advertising, television commercials, radio commercials, infomercials, Internet advertising, and email spam, for example. While the form of an advertisement may vary, its methods discussed above are always present. That is, an advertisement is a discrete form of communication that attempts to induce the public to buy, support, or approve something. Often, the public interprets advertising as being interruptive or invasive.

A clear distinction exists between advertising and sponsorship. Advertising is a form of communication that promotes one's own product, service, or idea with the goal of persuading the consumer to purchase, or become favorably aware of that which is advertised. In contrast, sponsorship is not a form of communication but a funding instrument whereby financial support is given to a vehicle an activity, event, service, or third-party product-in exchange for the opportunity to display and associate the sponsor's logo with the vehicle. Indirectly, the sponsor hopes to enhance its image and create greater awareness for its brand among a targeted audience.

For example, an athletic equipment manufacturer may finance (sponsor) an athletic event, not to sell its athletic equipment, but to publicly support the specific event and generally endorse the sport. A corporation may sponsor a public radio station, financially subsidizing its content and generally endorsing the activity of public radio.

Sponsorship can also financially support a person or group of persons. For example, a sponsor's logo could be strategically placed on an athlete's uniform during a sporting event. The sponsor's financial support is acknowledged from the display of its logo. However, like advertising, the display of the sponsor's name is merely an opportunity for consumers to see it, with no assurance that the consumer will, and no measure of the consumer's recognition.

The cost of sponsorship varies greatly and is determined by the vehicle. For example, a sponsor might give three hundred dollars to Colorado Public Radio or eleven million dollars to a NASCAR race team.

FIG. 1 illustrates relationships 100 established among an advertiser 110, a sponsor 120 and a consumer 130 via a vehicle 140. FIG. 1 utilizes solid lines 111, 121 and 141 to indicate a direct relationship, and broken lines 131 and 132 to indicate an opportunity for indirect exposure. Thus, a first direct relationship 111 is established between the advertiser 110 and the vehicle 140, a second direct relationship 121 is established between the sponsor 120 and the vehicle 140, and a third direct relationship 141 is established between the consumer 130 and the vehicle 140. The consumer 130 may establish the third direct relationship 141 by subscribing to the vehicle 140, whereby the consumer 130 pays a fee to the vehicle 140 via the third direct relationship 141 to read, view, listen to, or attend the vehicle 140. Furthermore, a first opportunity for indirect exposure 131 exists for the consumer 130 to passively be subjected to an advertisement of the advertiser 110, and a second opportunity for indirect exposure 132 exists for the consumer 130 to passively be subjected to a sponsorship logo of the sponsor 120.

The advertiser 110 pays the vehicle 140 a fee via the first direct relationship 111 for using the vehicle to potentially reach the consumer 130. The sponsor 120 financially supports the vehicle 140 via the second direct relationship 121 in exchange for logo display privileges.

To better understand the features of the present invention that distinguish it from the prior art, an exemplary prior art sponsorship instrument is now described.

Newspapers provide a medium for large-scale communication because they are ubiquitous in today's society, even though circulations are in decline. Newspapers are distributed in countless households, hotels, businesses, coffee shops, airports, train stations, street corners, and classrooms. They are a medium that provides various types of information to a wide and multigenerational audience. In an effort to promote the utilization of newspapers in teaching and education, many newspaper publishers have organized Newspaper in Education (NIE) programs. These programs are often 501(c)(3) charitable organizations whose mission is to promote and enable the use of newspapers in education. The NIE program of a typical newspaper creates curriculum and various other materials that incorporate newspapers into the educational process and distribute these materials to teachers and schools that request the program.

The NIE programs are most often non-profit entities that are funded by sponsorship dollars typically contributed by local businesses. In many cases a newspaper will also transfer “vacation donation dollars” (the portion of a home delivery subscription that goes unused because the subscriber is away from home, on vacation) to its own NIE program. Almost every newspaper's NIE program is financially supported by sponsorship dollars.

FIG. 2 is a flow diagram of a typical NIE sponsorship process 200. Sponsors, (e.g., local businesses), contribute dollars to the NIE program, or vacationing subscribers donate newspapers to the NIE program (step 205). The NIE program distributes to requesting school classrooms the donated newspapers and other teaching materials that promote and enable the use of the whole newspaper in an educational environment (step 210). The newspapers and the materials are distributed to teachers, classrooms, and schools that elect to participate in the NIE program. The dollars donated by the sponsors are used to pay for the materials and newspapers distributed as part of the NIE program. In return for the financial support of the NIE program, the sponsor may receive logo placement at the bottom of a dedicated NIE newspaper page, or logo placement in ads to promote NIE programs, or logo placement as part of the newspapers' thank you ads to sponsors, or logo placement as part of the promotional add-ons, e.g., rack cards, blank books, and the like (step 215). These logo placements are the sponsor's opportunity to gain potential consumer exposure. Where the sponsorship instrument is “vacation donation dollars,” NIE acknowledges the gift via the publication of its own logo.

The NIE sponsorship instrument can be described in terms of FIG. 1. The local business or vacationing subscriber provides financial support to the NIE program which distributes the newspaper (vehicle 140) to students (consumers 130) in the classroom. All readers of the newspaper have the opportunity to see the sponsor's logo on the bottom of a dedicated NIE page, or when the newspaper occasionally publishes NIE sponsorship thank you ads. This indirect recognition is represented by broken line 132. Classroom readers have the opportunity to see the sponsor's logo on support materials.

Similar to all sponsorship instruments, the prior art program provides very little accountability. There are no reports to the local business or vacationing subscriber detailing newspaper distribution. There is no accounting of how the sponsor's financial donation has been used. There are few quality control measures to ensure that a sponsor's logo is correctly displayed in the various ways previously mentioned. However, there is an opportunity for the sponsor to be recognized as a friend of education, if the general reader of the newspaper happens to recognize the sponsor's name among other newspaper content and a plethora of advertisements. Overall, the sponsor's support can be characterized as philanthropic rather than outcome-driven.

Depending on the vehicle, advertisers purchase space or time to disseminate their advertisements. The cost as determined by a prior art method is based on the amount of potential exposure of consumers to a vehicle as a whole, and not the number of consumers who are subjected to a particular advertisement. Thus, there is no measure of consumers who actually read, listen to, or view a particular advertisement or sponsor-linked Web site. Therefore, prior art advertising methods lack accountability.

Some prior art vehicles provide serialized content in which a continuing story or article is presented in parts, which are disseminated to the audience of the vehicles over a period of time. For example, a magazine may publish sequential installments of a story in daily, weekly or monthly issues. The serialized content serves as a dynamic product that can engender audience engagement and allegiance.

A method of exploiting serialized content by “imprinting” it with sponsor communication is desired. Furthermore, it would be desired to provide a metric of accountability for such imprinting by basing fees on measured consumer requests for the imprinted content.

### SUMMARY

The present invention is related to a method of creating and distributing sponsor-imprinted content used to catalyze consumer engagement with the sponsor. A content provider creates a content complex by imprinting content, (e.g., a narrative work), with a sponsor communication. The content and the sponsor communication may be serialized. The content complex is licensed to a provider of a vehicle, (e.g., a magazine, newspaper, radio, television, or a Web site accessed via the Internet), which presents the content complex to an audience, (e.g., readers, listeners, or viewers), of the vehicle. Accountable members of the audience, (i.e., those people who engage with the imprinted content), become consumers of the content complex. Additionally, independent consumers request the content complex prior to becoming accountable members of the audience. The content provider collects a fee from the sponsor based on the number of requests received for the content complex. The content provider pays a fee to the provider of the vehicle based on a measured consumer engagement yield.

### BRIEF DESCRIPTION OF THE DRAWINGS

A more detailed understanding of the invention may be had from the following description, given by way of example and to be understood in conjunction with the accompanying drawings wherein:

FIG. 1 illustrates relationships established among an advertiser, a sponsor and a consumer via a vehicle;

FIG. 2 is a flow diagram of a prior art NIE sponsorship process;

FIG. 3A shows an exemplary licensed content complex in accordance with the present invention;

FIG. 3B illustrates relationships established among a vehicle, the licensed content complex of FIG. 3A, an independent consumer and a sponsor in accordance with a preferred embodiment of the present invention; and

FIG. 4 is a flow diagram of an exemplary process of creating and distributing sponsor-imprinted content used to catalyze consumer engagement with the sponsor in accordance with the present invention.

### DETAILED DESCRIPTION OF THE PREFERRED EMBODIMENTS

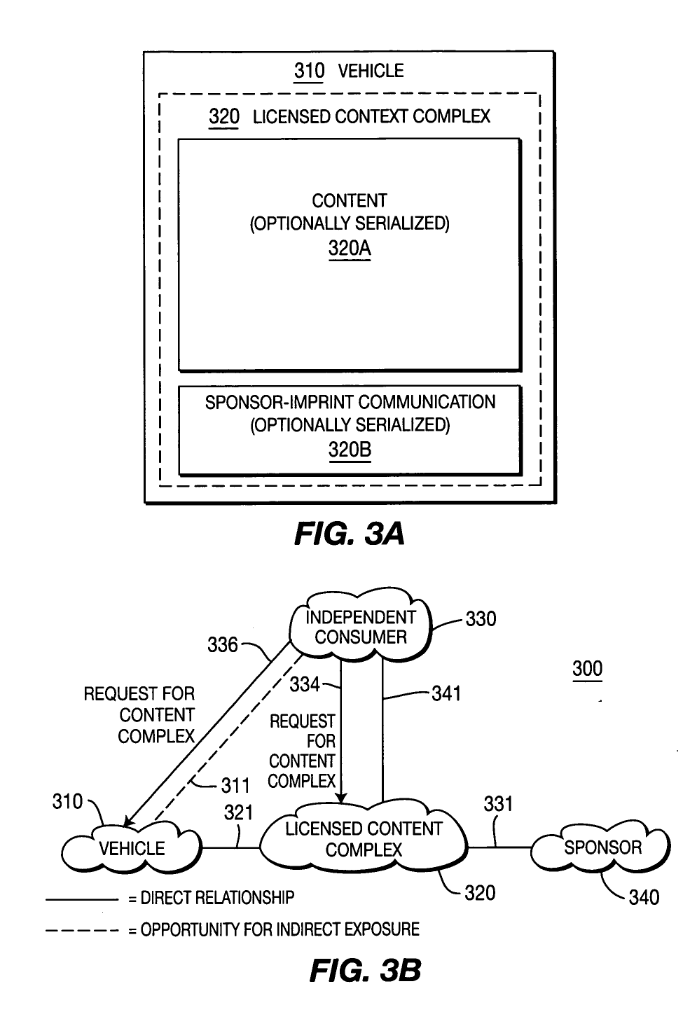

Referring to FIG. 3A, the present invention provides an imprinting process which directly engages the consumer with content 320A, (e.g., a narrative), and sponsor-imprint communication 320B, (e.g., a shorter narrative and a logo), that are brought together in close proximity, forming a content complex 320 which is licensed to a vehicle 310. The licensed content complex 320 undergoes a conformational change, thus increasing the consumer's affinity for the sponsor imprint.

Still referring to FIG. 3A, in one optional embodiment of the present invention, both the content 320A and the sponsor-imprint communication 320B are serialized, such as in the case of the content 320A being a narrative (e.g., literary work, radio story, or the like), with a particular number of installments, (e.g., chapters, episodes), and the sponsor-imprint communication 320B being a shorter narrative having the same number of installments as the content 320A. Alternatively, the sponsor-imprint communication 320B may be a simple non-promotional message and a logo. When the consumer and the sponsor come together in the correct orientation, the reactivity between them is maximized such that consumer engagement is specific and measurable.

The preferred embodiment of the current invention utilizes content in a form that conforms to the practical assumptions that consumers make about their daily lives. For example, consumers' lives are busy; consumers are socially inclined; consumers face competing choices; and all things preferred must be convenient and accessible. Therefore, when content is serialized over time, in convenient episodes; and when the content provides something to talk about with others; and when it offers the consumer a choice to return to each episode, using it any way they want to; and when it is accessible and convenient, the consumer is more likely to engage with it.

The present invention fastens sponsor communication to the content at a unique binding site. It fits together when the sponsor's communication also conforms to the practical assumptions that consumers make about their everyday experiences. For example, when the sponsor-imprint communication 320B is non-promotional, (e.g., when it is in a form that interacts with consumers rather than persuades or promises), and when it offers the consumer a choice to return for more, consumer engagement is specific and measurable.

The conformational change that occurs within the licensed content complex transforms the sponsor communication into consumer-centric dialogue. In so far as the consumer becomes the subject and an engaged consumer is the intended product of the method, cost is based on verifiable product, that is, independent consumers who directly engage with the complex, per installment or for the totality of installments. The vehicle's role is limited to a support platform which allows the catalytic-like complex to be widely distributed.

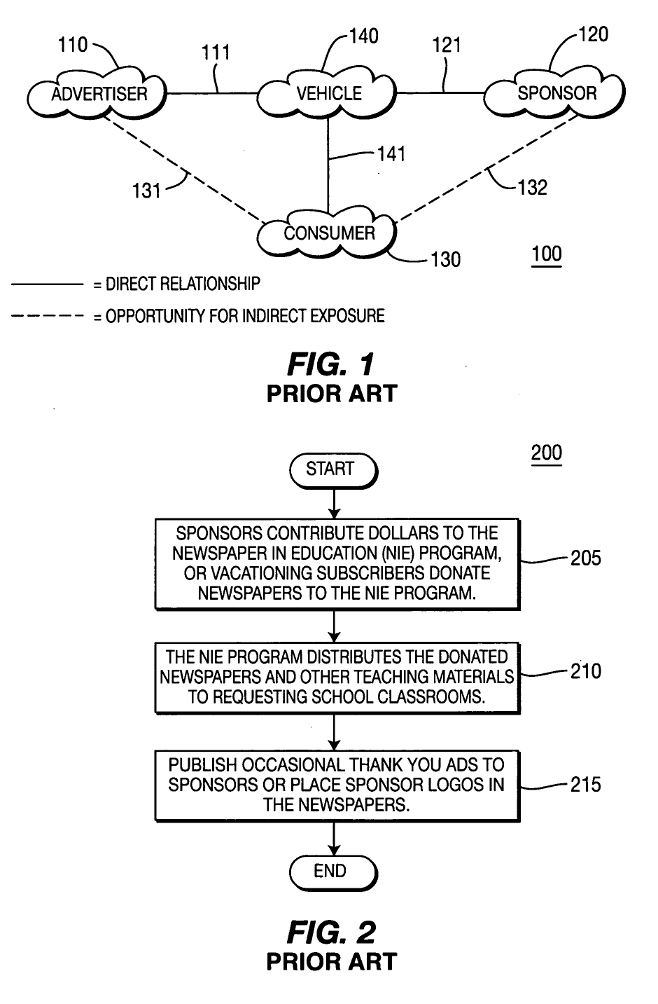

FIG. 3B illustrates relationships 300 established among a vehicle 310, a licensed content complex 320, an independent consumer 330 and a sponsor 340 in accordance with a preferred embodiment of the present invention. The vehicle 310 is utilized in a limited capacity. Unlike the prior art relationships 100 shown in FIG. 1 where the vehicle 140 sells space or time for the right to be widely distributed, the content complex 320 is licensed by at least one vehicle 310. FIG. 3B utilizes solid lines 321, 331 and 341 to indicate a direct relationship, and broken line 311 to indicate an opportunity for indirect exposure.

As previously mentioned while referring to FIG. 3A, the licensed content complex 320 comprises content 320A and sponsor-imprint communication 320B, which are held closely together in an orientation that catalyses consumer engagement with the sponsor. Although the independent consumer 330 typically uses the vehicle 310 for the sole purpose of accessing the content 320A, the format of the sponsor-imprint communication 320B is specifically designed to develop a positive attitude about the sponsor in the mind of the independent consumer 330. For example, the sponsor-imprint communication 320B may be a serialized “corporate” narrative that consumers use in a social context as they self-organize into emergent large-scale audience groups, (i.e., peer-to-peer, fathers and sons, colleagues at work), to share the content complex. In doing so, the content complex 320 can establish the sponsor as an object of trust and/or recognition in the behavior pattern of the audience groups.

Referring again to FIG. 3B, the independent consumer 330 specifically requests the licensed content complex 320, unlike the previously mentioned prior art advertising methods where the consumer requests the vehicle, not the advertisement. This occurs, for example, when an independent consumer 330 who doesn't already subscribe to a newspaper, (i.e., vehicle 310), contacts the newspaper to request a discrete subscription for the specific purpose of receiving the licensed content complex 320 for the duration that the licensed content complex 320 appears in the newspaper. The licensed content complex 320 is distributed to the independent consumer 330 by way of the vehicle 310. The sponsor 340 agrees to pay the provider of the licensed content complex 320 for all accountable consumer requests, which includes, but is not limited to, underwriting a discrete subscription to the vehicle 310 for the sole purpose of using the licensed content complex 320.

The sponsor 340 directly interacts with the provider of the licensed content complex 320 via the direct relationship 331 when the licensed content complex 320 is created. The vehicle 310 and the provider of the licensed content complex 320 directly interact when the vehicle 310 licenses and promotes the content complex 320, via the direct relationship 321.

The independent consumer 330 may obtain the licensed content complex 320 by submitting a request 334 to the provider of the licensed content complex 320 or by submitting a request 336 to the provider of the vehicle 310. For example, in response to a promotion of the content complex 320 by the vehicle 310, the independent consumer 330 may place a telephone call or facsimile to the provider of the licensed content complex 320 or the provider of the vehicle 310 requesting the licensed content complex 320. Alternatively, a Web site may be provided for receiving and processing the requests 334 and 336. Written forms of the requests 334 and 336 may also be sent by mail or E-mail in response to the promotion of the licensed content complex 320 by the vehicle 310. The requests 334 and 336 are measured, compiled and audited to determine fees paid by the sponsor to the provider of the content complex 320.

Differences between the prior art shown in FIG. 1, and the present invention as shown in FIG. 3A will now be discussed. Referring to the prior art relationships 100 shown in FIG. 1, the advertiser 110 pays a fee to the vehicle 140 for the opportunity to potentially reach the consumer 130, who may or may not look at the vehicle 140. The sponsor 120 donates financial support to the vehicle 140 for the opportunity to have its logo recognized by the consumer 130. In both cases, the consumer relationship with the advertiser or sponsor is indirect and shown as broken line 131 in the case of the advertiser 110, and as broken line 132 in the case of the sponsor 120. No engagement is guaranteed, as the consumer 130 may neglect the advertisement or logo. Additionally, the broken lines 131 and 132 represent an unknown and unknowable amount of potential contact.

Referring now to the relationships 300 of FIG. 3B in accordance with the present invention, the vehicle 310 licenses the content complex 320, which contains non-promotional communication of the sponsor 340. An independent consumer 330 specifically requests the licensed content complex 320. The independent consumer 330 engages with the licensed content complex 320 via direct relationship 341. The independent consumer 330 has an indirect relationship 311 with the vehicle 310, because the vehicle 310 serves only as the medium by which the independent consumer 330 receives the requested licensed content complex 320. Preferably, the means by which the licensed content complex 320 is disseminated is subscriber based.

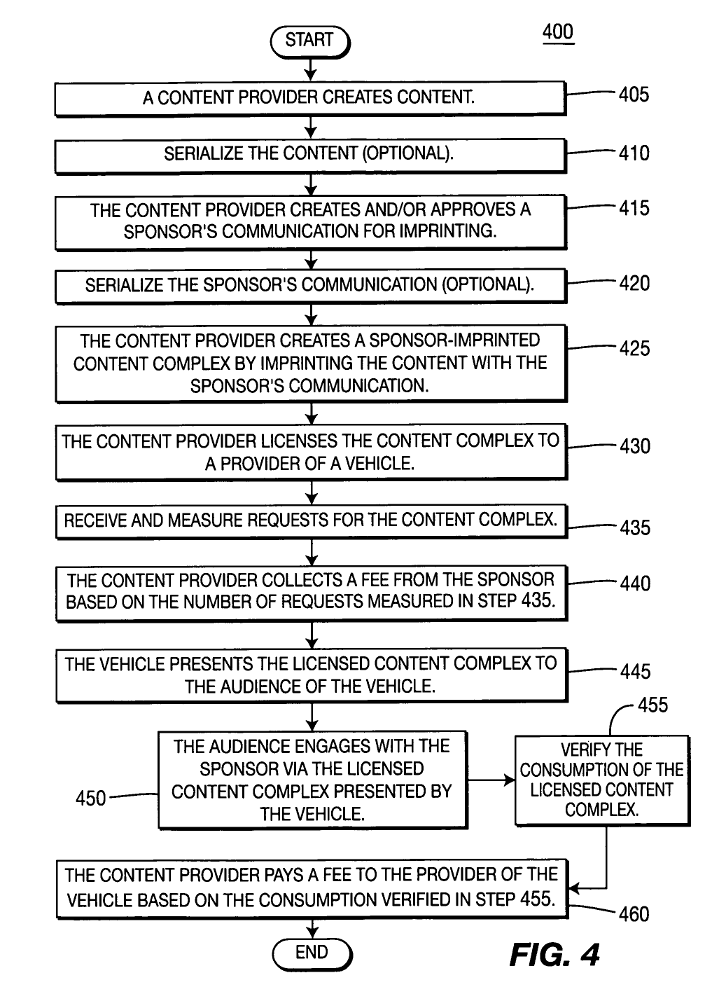

FIG. 4 is a flow diagram of an exemplary process 400 of creating and distributing sponsor-imprinted content used to catalyze consumer engagement with the sponsor in accordance with the present invention. In step 405, the content 320A is created by a content provider. In optional step 410, the content 320A is serialized. In step 415, the content provider creates and/or approves a sponsor's communication 320B for imprinting. In step 420, the sponsor's communication 320B is serialized if the content 320A is serialized, such that the content 320A and the sponsor's communication 320B have the same number of installments, (e.g., chapters). In step 425, the content provider creates a sponsor-imprinted content complex 320 by imprinting the content 320A with the sponsor's communication 320B.

Still referring to FIG. 4, the content provider licenses the content complex 320 to a provider of a vehicle 310 (step 430). In step 435, requests for the content complex 320 are received and measured. In step 440, the content provider collects a fee from the sponsor 340 based on the number of requests measured in step 435. In step 445, the vehicle 310 presents the licensed content complex 320 to the audience of the vehicle 310. In step 450, the audience engages with the sponsor 340 via the licensed content complex 320 presented by the vehicle 310.

Still referring to FIG. 4, the consumption of the licensed content complex 320 is verified (step 455). The verification step 455 includes gathering and summarizing affidavits received from independent consumers stating that the licensed content complex was requested, received, and used. A summary report of these affidavits specifies levels of consumer engagement yield. The vehicle then approves the summary. The summary report is then presented to the licensed content provider to substantiate the sponsor's financial agreement.

In step 460, the content provider pays a fee to the provider of the vehicle 310 based on the consumption verified in step 455, which indicates a measured consumer engagement yield. The compilation of vehicle data, (e.g., monthly Publisher Reports), is preferably carried out in accordance with the Auditing Bureau of Circulation (ABC) guidelines.

The fee structure of the present invention is based on consumer requests and engagement yield. This is an improvement over the prior art as the opportunity to gain consumer awareness for an announcement or logo lacks accountability. Furthermore, the sponsor pays only for the engaged consumer experience, thereby receiving more value for every sponsor dollar invested. Unlike advertising methods and sponsorship instruments, the inventive method is completely transparent as it catalyzes and measures consumer engagement.

It should be understood by one skilled in the art that organizations exist to measure circulation, viewership, listenership, or other forms of consumer participation depending on the vehicle by which the licensed content complex is conveyed. For example, Neilson Media Research compiles television viewership data. In alternative embodiments of the present invention in which other vehicles are used, the sponsorship fees will be expressed as a percent of industry standard participation data compiled by these other various organizations.

Since the inventive method exemplified in FIG. 4 is based on consumer engagement yield, the sponsor of the licensed content complex 320 underwrites only those engaged consumers who specifically request the licensed content complex 320. Stretch this investment over the vehicle's total audience and the opportunity costs to engage consumers is considerably lower than the cost of prior art methods.

In an alternate embodiment, a content provider creates a sponsor-imprinted content complex by imprinting content with a sponsor's communication. The content provider presents the sponsor-imprinted content complex, and consumers engage with the sponsor via the sponsor-imprinted content complex presented by the content provider. The sponsor-imprinted content complex may be presented at a Web site and/or may be accessed via the Internet.

In another embodiment of the present invention, a periodical publication is created and distributed which presents sponsor-imprinted content. The periodical publication comprises a plurality of pages, and a sponsor-imprinted content complex that is presented on at least one of the pages. The sponsor-imprinted content complex may be licensed to a provider of the publication by a content provider that creates the sponsor-imprinted content complex by imprinting content with a sponsor's communication. The publication presents the licensed content complex to an audience for catalyzing consumer engagement with the sponsor via the licensed content complex presented by the periodical publication. The periodical publication may present the licensed content complex to the audience at a Web site and/or may access the licensed content complex of the periodical publication via the Internet.

In yet another embodiment of the present invention, a plurality of requests for the content complex created by a content provider are received from consumers who are not members of the audience. The content complex comprises content imprinted with a sponsor's communication. The number of requests for the content complex is measured. The sponsor pays a fee to the content provider based on the measured number of requests for the content complex. The consumers who are not members of the audience become accountable members of the audience after submitting the requests.

Although the present invention has been described in detail by reference to the preferred embodiment, it is to be understood that the invention is not limited thereto, and that various changes can be made therein without departing from the spirit and scope of the invention, which is defined by the attached claims.

What is claimed is:

1. A method of creating and distributing sponsor-imprinted content, the method comprising:
(a) a content provider creating a sponsor-imprinted content complex by imprinting content with a sponsor's communication;
(b) the content provider licensing the content complex to a provider of a vehicle;
(c) the vehicle presenting the licensed content complex; and
(d) engaging consumers with the sponsor via the licensed content complex presented by the vehicle.

2. The method of claim 1 further comprising:
(e) serializing the content into a plurality of N installments; and
(f) serializing the sponsor's communication into a number of installments equal to N.

3. The method of claim 1 wherein the content comprises a narrative work.

4. The method of claim 1 wherein the vehicle is a magazine.

5. The method of claim 1 wherein the vehicle is a newspaper.

6. The method of claim 1 wherein the vehicle is radio.

7. The method of claim 1 wherein the vehicle is television.

8. The method of claim 1 wherein the vehicle is accessed via the Internet.

9. The method of claim 1 wherein the vehicle is a Web site.

10. The method of claim 1 wherein the consumers are a subset of an audience of the vehicle.

11. The method of claim 1 wherein a fee is paid by the sponsor to the content provider based on a number of requests received for the content complex.

12. The method of claim 1 wherein a fee is paid by the content provider to the provider of the vehicle based on reports generated in accordance with Audit Bureau of Circulation (ABC) guidelines.

13. The method of claim 1 wherein a fee is paid by the content provider to the provider of the vehicle based on a measure of at least one of circulation, viewership and listenership.

14. The method of claim 1 further comprising:
(e) verifying consumption of the licensed content complex; and
(f) determining an amount of a fee to be paid by the content provider to the provider of the vehicle based on the verified consumption.

15. The method of claim 14 wherein the verified consumption indicates a measured consumer engagement yield.

16. A method of disseminating content with strategic sponsorship, the method comprising:
(a) a content provider creating content with a predetermined number of installments;
(b) the content provider generating a content complex by imprinting each of the installments of the content with respective sponsor communications;
(c) the content provider licensing the content complex to a provider of a vehicle having an audience; and
(d) the vehicle presenting the licensed content complex to the audience, wherein at least a portion of the audience requested the content complex from at least one of the content provider and the provider of the vehicle prior to becoming a member of the audience.

17. The method of claim 16 further comprising:
(e) verifying consumption of the licensed content complex; and
(f) determining an amount of a fee to be paid by the content provider to the provider of the vehicle based on the verified consumption.

18. The method of claim 17 wherein the fee is based on reports generated in accordance with Audit Bureau of Circulation (ABC) guidelines.

19. The method of claim 17 wherein the fee is based on a measure of at least one of circulation, viewership and listenership.

20. The method of claim 18 wherein the verified consumption indicates a measured consumer engagement yield.

21. The method of claim 16 wherein the content comprises a narrative work.

22. The method of claim 16 wherein the vehicle is a magazine.

23. The method of claim 16 wherein the vehicle is a newspaper.

24. The method of claim 16 wherein the vehicle is radio.

25. The method of claim 16 wherein the vehicle is television.

26. The method of claim 16 wherein the vehicle is accessed via the Internet.

27. The method of claim 16 wherein the vehicle is a Web site.

28. A method of creating and distributing sponsor-imprinted content, the method comprising:
(a) a content provider creating a series of sponsor-imprinted content complexes by imprinting content with respective sponsor communications;
(b) the content provider licensing the series of sponsor-imprinted content complexes to a provider of a vehicle;
(c) the vehicle presenting the licensed content complexes; and
(d) engaging consumers with the sponsor via the licensed content complexes presented by the vehicle.

29. The method of claim 28 wherein the consumers are a subset of an audience of the vehicle.

30. The method of claim 28 wherein the content comprises a narrative work.

31. The method of claim 28 wherein the vehicle is a magazine.

32. The method of claim 28 wherein the vehicle is a newspaper.

33. The method of claim 28 wherein the vehicle is radio.

34. The method of claim 28 wherein the vehicle is television.

35. The method of claim 28 wherein the vehicle is accessed via the Internet.

36. The method of claim 28 wherein the vehicle is a Web site.

37. The method of claim 28 wherein a fee is paid by the sponsor to the content provider based on a number of requests for the content complexes.

38. The method of claim 28 wherein a fee is paid by the content provider to the provider of the vehicle based on reports generated in accordance with Audit Bureau of Circulation (ABC) guidelines.

39. The method of claim 28 wherein a fee is paid by the content provider to the provider of the vehicle based on a measure of at least one of circulation, viewership and listenership.

40. The method of claim 28 further comprising:
(e) verifying consumption of the licensed content complex; and
(f) determining an amount of a fee to be paid by the content provider to the provider of the vehicle based on the verified consumption.

41. The method of claim 40 wherein the verified consumption indicates a measured consumer engagement yield.

42. A periodical publication for presenting sponsor-imprinted content, the periodical publication comprising:
(a) a plurality of pages; and
(b) a sponsor-imprinted content complex that is presented on at least one of the pages, the sponsor-imprinted content complex being licensed to a provider of the publication by a content provider that creates the sponsor-imprinted content complex by imprinting content with a sponsor's communication, wherein the publication presents the licensed content complex to an audience for catalyzing consumer engagement with the sponsor via the licensed content complex presented by the periodical publication.

43. The periodical publication of claim 42 wherein the content complex is serialized into a plurality of installments.

44. The periodical publication of claim 42 wherein the content comprises a narrative work.

45. The periodical publication of claim 42 wherein the sponsor-imprinted content complex (b) comprises:
(b1) one of N installments of a narrative work that is presented on the pages of successive issues of the publication; and
(b2) one of N installments of the sponsor's communication that is presented in close proximity to the installment of the narrative work.

46. The periodical publication of claim 42 wherein the periodical publication presents the licensed content complex to the audience at a Web site.

47. The periodical publication of claim 42 wherein the audience accesses the licensed content complex of the periodical publication via the Internet.

48. A method of creating and distributing sponsor-imprinted content for presentation by a vehicle to an audience of the vehicle, the method comprising:
(a) receiving a plurality of requests for the content complex created by a content provider from consumers who are not members of the audience, the content complex comprising content imprinted with a sponsor's communication;
(b) measuring the number of requests for the content complex; and
(c) the sponsor paying a fee to the content provider based on the measured number of requests for the content complex.

49. The method of claim 48 wherein the content is serialized into a plurality of installments.

50. The method of claim 49 wherein the sponsor's communication is serialized into a plurality of installments equal to the number of installments of the serialized content.

51. The method of claim 48 wherein the requests are received at a Web site.

52. The method of claim 48 wherein the requests are received via telephone or facsimile.

53. The method of claim 48 wherein the requests are received via E-mail.

54. The method of claim 48 wherein the requests are received in writing.

55. The method of claim 48 wherein the consumers who are not members of the audience become accountable members of the audience after submitting the requests.

56. A method of creating and distributing sponsor-imprinted content for presentation by a vehicle to an audience of the vehicle, the method comprising:
(a) a content provider creating a sponsor-imprinted content complex by imprinting content with a sponsor's communication;
(b) the content provider licensing the content complex to providers of vehicles;
(c) verifying the consumption of the licensed content complex by the audience of each of the vehicles; and
(d) the content provider compensating the providers of the vehicles based on the verified consumption of each vehicle.

57. The method of claim 56 wherein the compensation is based on reports generated in accordance with Audit Bureau of Circulation (ABC) guidelines.

58. The method of claim 56 wherein the compensation is based on a measure of at least one of circulation, viewership and listenership.

59. The method of claim 56 wherein the verified consumption indicates a measured consumer engagement yield.

60. A method of creating and distributing sponsor-imprinted content, the method comprising:
(a) a content provider creating a sponsor-imprinted content complex by imprinting content with a sponsor's communication;
(b) the content provider presenting the sponsor-imprinted content complex; and
(c) engaging consumers with the sponsor via the sponsor-imprinted content complex presented by the content provider.

61. The method of claim 60 wherein the sponsor-imprinted content complex is presented at a Web site.

62. The method of claim 60 wherein the sponsor-imprinted content complex is accessed via the Internet.
